(19) United States
(12) Patent Application Publication
(10) Pub. No.: US 2014/0062148 A1
(43) Pub. Date: Mar. 6, 2014

(54) Vehicle Elbow and Arm Rest (VEAR)

(71) Applicant: René Agosto, Schertz, TX (US)

(72) Inventor: René Agosto, Schertz, TX (US)

(21) Appl. No.: 13/598,060

(22) Filed: Aug. 29, 2012

(51) Int. Cl. B60N 2/58

(52) U.S. Cl. 297/219.1

(57) ABSTRACT

This invention provides improved arm/elbow comfort for motor vehicle drivers and passengers. This structure includes a thick padding covered by a thin material and fasteners used to adjust the straps around the intended object while providing increased comfort to the user.

### CROSS-REFERENCE TO RELATED APPLICATIONS

No claims are being made to priority on any provisional patent applications.

### BACKGROUND OF THE INVENTION

This invention will provide comfort to vehicle drivers and the passenger as well. Today's vehicle either has a storage area or an arm-rest that is uncomfortable that can be traumatic to the elbow and the entire arm. The Vehicle Elbow-Arm rest is basically a layer of foam (1″ thick) between two pieces of thin material, normally 12″×12″. The size will fluctuate depending on the size of the vehicle. The primary material will be made from soft cotton or soft form and with a material that will be easy to clean. The rear of the arm-rest will have an opening, that will have two too flaps. Each flap will have Velcro, which you can open and close to facilitate easy access to the form. The form can be replaced and cleaned when desired. The Elbow-Rest will have two straps on its left and right side. Open the Vehicles' storage/arm-rest door and strap the Elbow-rest straps around the storage/arm-rest door, and then close the storage door. You will be able to adjust the VAER around the vehicle storage door. Afterwards, you can rest your elbow and arm on the Elbow-Rest pad.

### BRIEF SUMMARY OF THE INVENTION

My invention will enhance the comfort of the current arm-rest, by providing an extra layer of relief. You will feel the relaxation as soon as you lay your elbow on the Elbow-rest. You will feel the coziness of your triceps and biceps muscles relaxing and reducing the discomfort, stress or pain.

### BRIEF DESCRIPTION OF THE SEVERAL VIEWS OF THE DRAWING

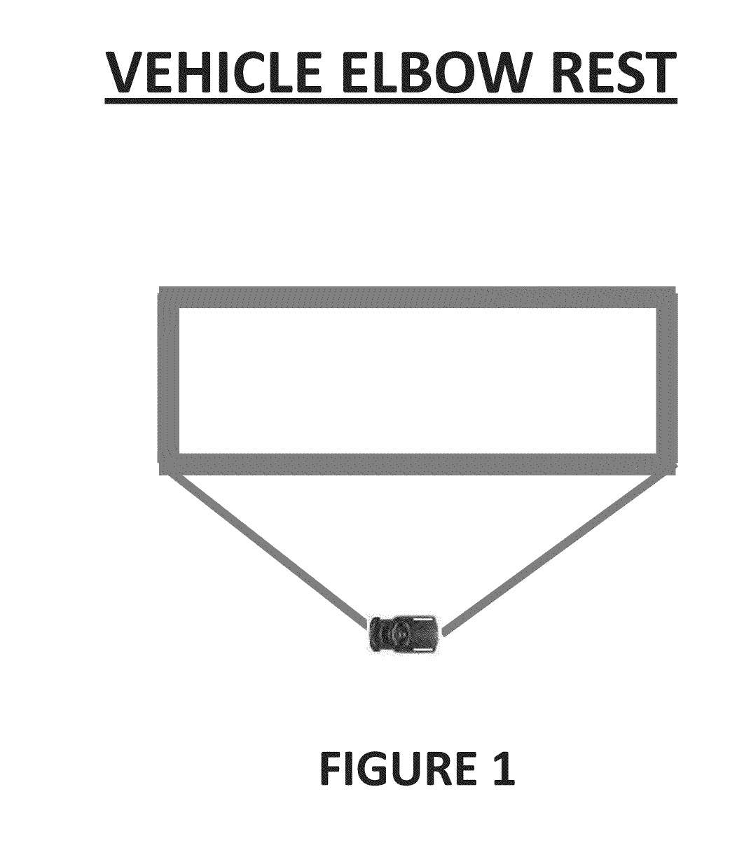

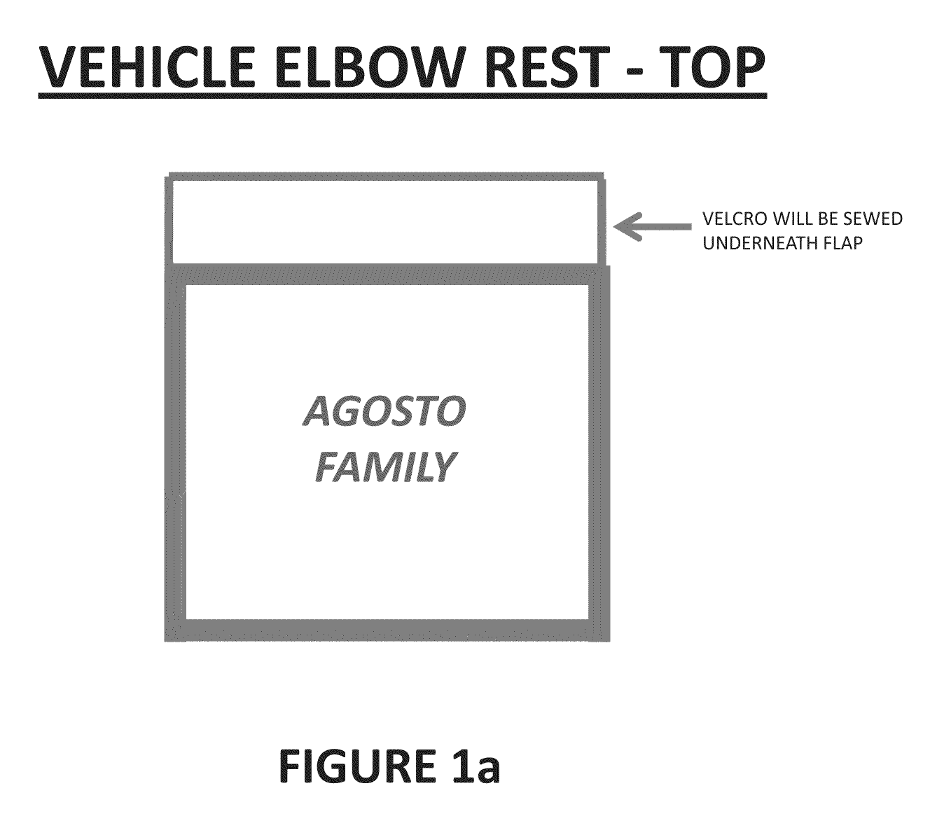

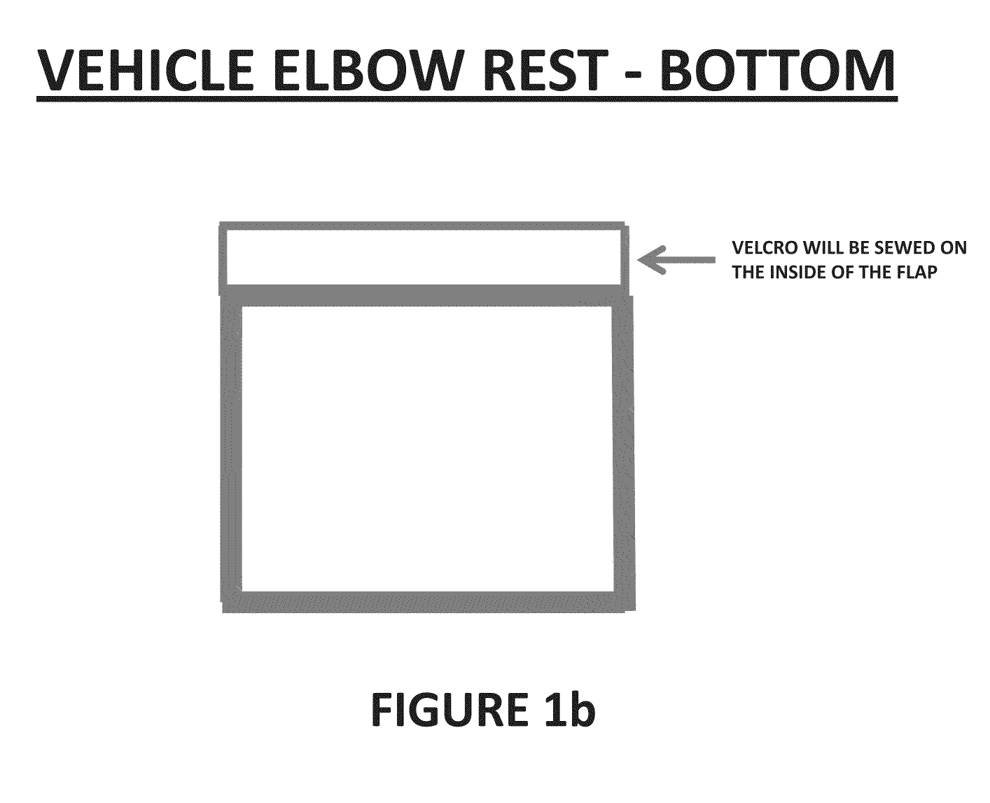

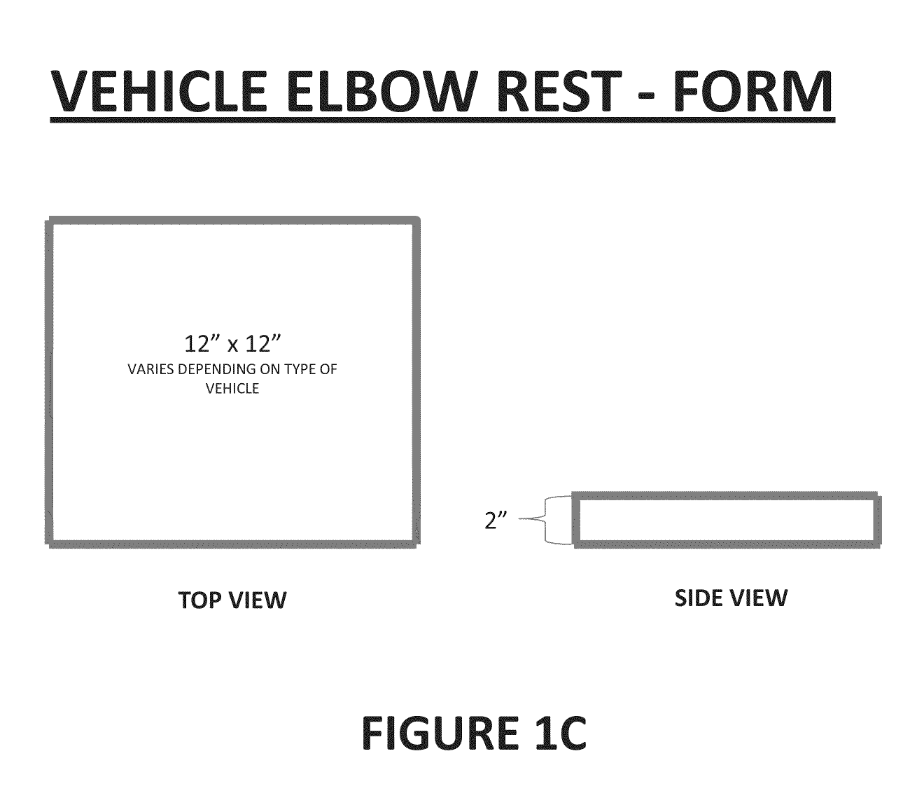

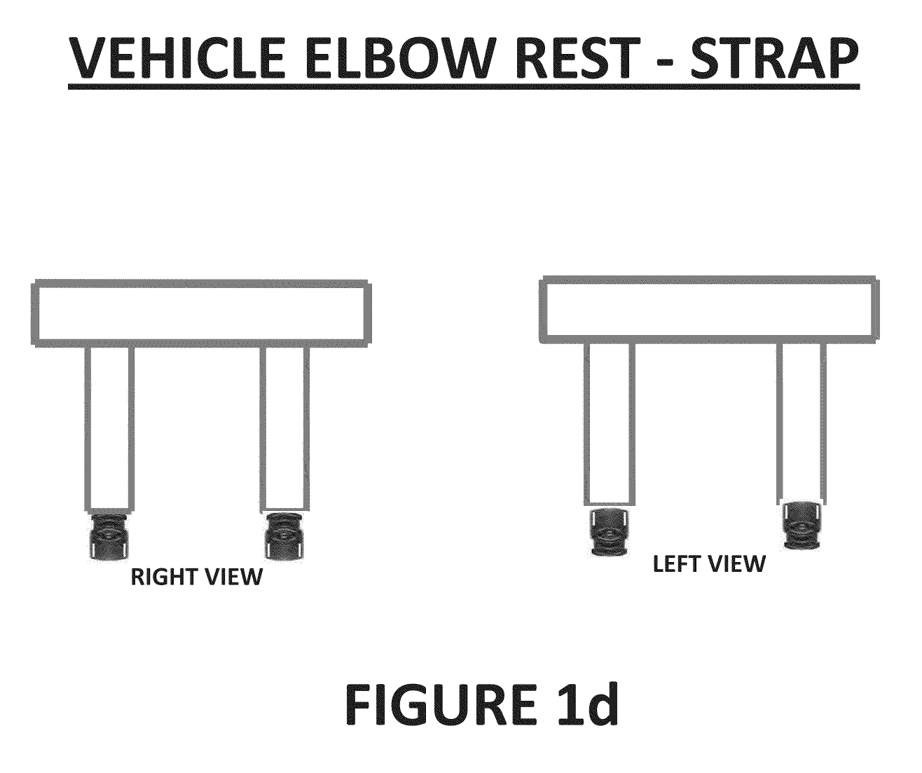

The draft illustrates the Vehicle Elbow-Arm Rest—VEAR (FIG. 1—front view). FIG. 1a is the upper cloth with the flap (the Velcro will be placed underneath the flap); this will be sewed to the bottom portion. Logos and other interesting wording can be annotated for added gratification. The bottom portion of the VEAR (FIG. 1b), is a leather or cloth base for the VEAR, the Velcro will be sewed in the inside of the flap. The form (FIG. 1c) will be inserted in between the VEAR. The straps will be elastic and sewed to the two sides of the VEAR (FIG. 1d).

### DETAILED DESCRIPTION OF THE INVENTION

The VEAR will provide improved arm/elbow comfort for motor vehicle drivers and passengers. It will come in different colors, soft cotton material. The bottom portion will be the base and a leather type material. The material will facilitate easy cleaning. This structure includes a padded 12×12 surface area covered by a thin material securely sewed to adjustable straps that can be attached to any arm rest with the use of the attached buckles to increase comfort to the arm/elbow region. It will enhance the comfort of the current arm-rest, by providing an extra layer of relief and adjustability. You will feel the relaxation as soon as you lay your elbow on the Elbow-rest. You will feel the coziness of your triceps and biceps muscles relaxing and reducing the discomfort, stress or pain.

1. The embodiments of the elbow/arm rest in which an exclusive property or privilege is claimed are defined as compromising: a padded 12×12 surface area covered by a thin material securely sewed to adjustable straps that can be attached to any arm rest with the use of the attached buckles to increase comfort to the arm/elbow region.
